(19) United States
(12) Patent Application Publication
(10) Pub. No.: US 2025/0304840 A1
(43) Pub. Date: Oct. 2, 2025

(54) PRESSURIZED AEROSOL ADHESIVE COMPOUND

(71) Applicant: Vitaliy Ivanovich Titorov, Moscow (RU)

(72) Inventor: Vitaliy Ivanovich Titorov, Moscow (RU)

(21) Appl. No.: 19/024,842

(22) Filed: Jan. 16, 2025

(30) Foreign Application Priority Data
Mar. 26, 2024 (RU) 2024107789

(51) Int. Cl. C09J 175/08; C08G 18/10; C08G 18/16; C09J 9/00

(52) U.S. Cl. CPC C09J 175/08; C08G 18/10; C08G 18/16; C09J 9/00; C08G 2170/00; C08G 2220/00

(57) ABSTRACT

The invention relates to an adhesive composition that is capable of being subsequently released into the environment in a controlled and measured manner and is primarily used for construction purposes. The pressurized adhesive composition in a can is such that a) when released from the aerosol can, it has the consistency of a gel or paste; b) has a shear strength, measured in accordance with the standard “ASTM D905-08 (Reapproved 2021)”, of 80 psi or higher, when the adhesive composition is applied to wood, such as hard maple. High wood material bonding strength is provided.

### FIELD OF THE INVENTION

The proposed invention relates to integral packaging, made, for example, in the form of an aerosol tube or can, inside which an adhesive aerosol composition is contained under pressure, capable of subsequently being released in a controlled and dosed manner into the external environment, where the adhesive compound can be primarily used for construction purposes.

### BACKGROUND OF THE RELATED ART

The prior art discloses an aerosol can that stores and doses a pressurized aerosol composition and comprises a composition internal coating composition (see RU2710431, cl. C09D5/03, publ. 26.12.2019 [1]).

In terms of design, a prior art solution [1] relates to aerosol-containing one-piece aerosol tubes/cans, additionally comprising a coating composition on at least a portion of its internal working surface.

A coating (composition) is applied to the inner surfaces of the containers (aerosol tubes/cans), mostly to protect the can from its contents, which in many cases are chemically aggressive. In addition, such coating should protect the contents from the can material.

Thus, the essence of the solution is mainly aimed at ensuring that the contents of the container (can/tube) should not actually be subject to significant changes under the influence of substances that are products of the container's erosion. Accordingly, the composition of the inner coating used for this purpose should resist contact with aggressive chemicals and at the same time minimize the release of the substance from the walls of the package or the coating layer into the contents of the can.

The coating composition according to the prior art solution [1] is capable of withstanding contact with alkaline chemicals, in addition, the coating compositions according to the prior art solution [1] can be used as a mono-layer or as part of a multi-layer system, the coating compositions can also be used as primer coating and can be applied over another layer of paint as part of a multi-layer system.

At the same time, the coating compositions can form an intermediate layer or a top layer, moreover, the coating compositions can be applied once or repeatedly.

The following are the disadvantages of the prior art solution [1].

An aerosol container from the prior art in the form of a can or tube is mainly used for household needs and is primarily intended for storage and dosed release of aerosol compositions, such as foams and mousses for shaving, deodorizing compositions, as well as personal care products and personal hygiene products with another structure and composition, whereas the versatility of application and expansion of the application field is not ensured, since the additional coating composition does not have guaranteed characteristics capable of neutralizing and maintaining a functional form, including that of chemically and physically active substances, such as adhesives of organic or inorganic origin used in various industries and household conditions.

An additional noteworthy disadvantage is the high complexity of production, as well as the unjustified and unconfirmed usability and efficiency of using aerosol containers from the prior art, since the application of an additional coating composition is associated with a number of manufacturing steps, in particular requiring compliance with the application technology and the use of specialized equipment, which in turn increases the production time and complicates the process, unquestionably increasing the production cost of product batches.

A known prior art is an aqueous adhesive composition applied using an aerosol agent (see RU2723170, cl. C09D105/00, publ. 09.06.2020 [2]). This prior art solution [2] relates to an aqueous adhesive composition intended for obtaining a water-based adhesive.

The prior art adhesive composition contains a number of key (essential) components in a certain amount, which serves as the basis and determines the technical possibility of using it under pressure in an aerosol can, to obtain an adhesive primarily used for producing high-quality wood material, such as plywood, veneer, chipboard, fiberboard, etc.

It should be noted that the above materials are generally produced by applying or spraying an adhesive onto wood raw materials (e.g. different fiber sizes, small pieces and veneers) and then pressing them, if necessary, by increasing pressure and heating.

The prior art solution [2] was essentially created to work with wood material, which can be obtained using an aqueous adhesive composition, which in turn has high characteristics, such as bending strength, durability, water absorption, etc.

The following disadvantages of the prior art solution [2] should be noted.

According to the description of the prior art technical solution [2], the resulting wood material has high properties (ultimate bending strength, ultimate peel strength, water absorption capabilities, etc.), however, a specialist is still aware from the prior art that the parameters of water-based adhesives are very often unstable and unsatisfactory, thus there is reason to assume that the specified improved parameters of wood material have no long-term stability and can lose their useful properties over time, especially when exposed to atmospheric factors and phenomena such as solar radiation, precipitation, wind, humidity, temperature, etc.

As indicated above, the essence of the prior art solution [2] relates to the production of various types of wood material, and this is the actual extent of the concept and technical capabilities, which in a certain aspect can be perceived in the construction segment as an advantage and specific feature for lumber processing, however, in the conditions of active market competition and taking into account the high cost of wood raw materials, this narrow focus may not meet market expectations and may not find a wide consumer response, wholesale or retail, which will not contribute to the development or strengthening of the relevant production capacities, thereby suggesting an additional disadvantage, which a limited effective application field.

### SUMMARY OF THE INVENTION

The technical problem of the proposed invention is the creation of an adhesive composition with high performance characteristics placed in a pressurized container.

The technical result of the proposed invention is obtaining an adhesive composition in the form of a gel or paste with an increased wood material bonding strength, released from an aerosol container.

The specified technical result and the solution to the specified technical problem are achieved by the fact that the adhesive composition under pressure in the container is characterized by having the consistency of a gel or paste when released from the aerosol container, and by the fact that it has a shear strength, measured in accordance with the standard ASTM D905-08 (Reapproved 2021), “Standard Test Method for Strength Properties of Adhesive Bonds in Shear by Compression Loading” of 80 psi and higher, when the adhesive composition is applied to hard maple.

The consistency of a gel or paste when released from the aerosol can is provided by a polyurethane base.

In a particular embodiment of a pressurized adhesive composition, it has a shear strength measured in accordance with ASTM D905-08 (Reapproved 2021) of 90 psi or greater when applied to hard maple.

In a particular embodiment of a pressurized adhesive composition, it has a shear strength measured in accordance with ASTM D905-08 of 100 psi or greater when applied to hard maple.

In a particular embodiment of a pressurized adhesive composition, it has a shear strength measured in accordance with ASTM D905-08 of 110 psi or greater when applied to hard maple.

In a particular embodiment of a pressurized adhesive composition, it has a shear strength measured in accordance with ASTM D905-08 of 120 psi or greater when applied to hard maple.

In a particular embodiment of a pressurized adhesive composition, it has a shear strength measured in accordance with ASTM D905-08 of 130 psi or greater when applied to hard maple.

In a particular embodiment of a pressurized adhesive composition, it has a shear strength measured in accordance with ASTM D905-08 of 140 psi or greater when applied to hard maple.

In a particular embodiment of a pressurized adhesive composition, it has a shear strength measured in accordance with ASTM D905-08 of 150 psi or greater when applied to hard maple.

When released from the aerosol can, the adhesive has the consistency of a gel or paste, and according to ASTM D905-08, the gel or paste has a shear strength of 80 to 150 psi or greater when applied to hard maple.

In the process of implementing the proposed product, it was unexpectedly discovered that the characteristic technical features of the adhesive composition in accordance with the concept of the invention do not ensure foaming of the chemical adhesive composition inside the aerosol can when releasing the adhesive composition; when released from the aerosol can, the chemical adhesive composition has the form of an adhesive gel or adhesive paste, and the gases used in the aerosol container can be any gases, as well as mixtures of gases in different proportions.

The use of an adhesive composition in an aerosol container is justified by improved ergonomics, as it is possible to stop pressing on the dosing element of the pressurized container under pressure at any time, and the dosing will stop, while no excess product will not come out or drip, which protects the surfaces.

If the task is to apply bulk adhesive layers, then when the release of adhesive is stopped, the outlet is completely blocked and there is no leakage of the adhesive composition.

The first component is mixed in a separate metal or plastic reactor, according to the specified quantitative and qualitative composition, using an anchor, blade or any other mixer. After mixing, the prepared mixture (prepolymer) is fed through a dispenser into an aerosol container. Then, a second component is fed through a separate dispenser in the form of polymeric methylene diphenyl diisocyanate, polymeric diphenylmethane diisocyanate, 4,4′-diphenylmethane diisocyanates, polymethylene polyphenylene polyisocyanates, polymeric MDI, polymethylene polyphenylene isocyanate ester, a mixture of mixed isomers of methylene diphenyl diisocyanate and carbodiimide-modified 4,4′-methylene diphenyl diisocyanate with a prepolymer based on polyoxypropylene glycol, or a mixture of any of these components.

After this, a valve is affixed onto the aerosol can.

The next step is to dose the gas or gas mixture into the aerosol can through the fitted valve.

Generally, the components above may be in the following proportions:

Percentage by weight of each component in the entire composition

| | | |
|---|---|---|
| | Wide | Preferred |
| Component | range (%) | range (%) |

First component

| | | |
|---|---|---|
| Polyether(s) | 0-53 | 15-45 |
| Polyester(s) | 0-53 | 15-45 |
| Flame retardant(s) | 1.5-28 | 8.5-15 |
| Catalyst(s) | 0.1-2.5 | 0.4-1.2 |
| Mixture of any of the components of | 0-83.5 | 30-55 |
| the 1st component | | |

Second component

| | | |
|---|---|---|
| Polymeric methylene diphenyl | 0-95 | 35-58 |
| diisocyanate(s) | | |
| Polymeric diphenylmethane | 0-95 | 35-58 |
| diisocyanate(s) | | |
| 4,4′-diphenylmethane diisocyanate(s) | 0-95 | 35-58 |
| Polymethylenepolyphenylene | 0-95 | 35-58 |
| polyisocyanate(s) | | |
| Polymeric MDI | 0-95 | 35-58 |
| Polymethylenepolyphenylene | 0-95 | 35-58 |
| isocyanate ester(s) | | |
| A mixture of mixed isomer(s) of | 0-95 | 35-58 |
| methylene diphenyl diisocyanate | | |
| and carbodiimide(s)-modified | | |
| 4,4′-methylene diphenyl diisocyanate(s) | 0-95 | 35-58 |
| with a polyoxypropylene glycol-based | | |
| prepolymer(s) | | |
| Mixture of any of the components of | 0-95 | 35-58 |
| the 2nd component | | |

Third component

| | | |
|---|---|---|
| Gas or gas mixture | 2-38 | 9.2-22 |

It was established during experimental work that the components of the adhesive composition form a high-quality adhesive structure with consistently reliable and high wood material bonding strength indicators.

Thus, features of parts and characteristics of adhesive components placed in a pressurized container predetermine the essential features necessary and sufficient to achieve the specified technical result, which consists in implementing the purpose of obtaining an adhesive gel or adhesive paste composition with an increased wood material bonding strength, released from an aerosol container, which actually implements the solution to the specified technical problem of creating an adhesive composition placed in a pressurized container with high technical and performance indicators.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 shows an image of aerosol cans with the proposed pressurized adhesive composition inside;

FIG. 2 shows an image of two hard maple samples bonded together using an adhesive composition;

FIG. 3 shows a general view of the setup for performing a standard shear test under load;

FIG. 4 shows a fragment of FIG. 3 with a highlighted area with the test samples.

### DETAILED DESCRIPTION OF EMBODIMENTS OF THE INVENTION

Reference will now be made in detail to the preferred embodiments of the present invention, examples of which are illustrated in the accompanying drawings.

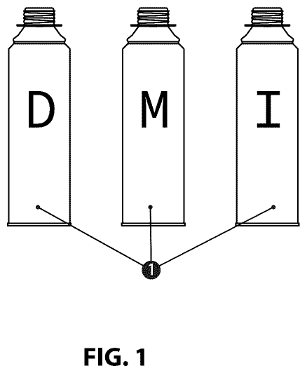

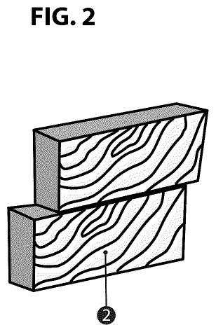

FIGS. 1-4 indicate the following parts and elements used in the implementation of the proposed pressurized aerosol adhesive composition:
1—pressurized containers (aerosol cans);
2—wood material samples (wood blanks made of hard maple);
3—standard setup for shear testing under load;
symbol D—adhesive composition No. 1 (a composition from the prior art);
symbol M—adhesive composition No. 2 (a composition from the prior art);
symbol I—adhesive composition No. 3 (the invented product).

The proposed pressurized product (aerosol adhesive composition) can be obtained using a generally accepted manufacturing method presented below, and the possibility of implementing the designated purpose and achieving the technical result together with solving the current technical problem is further confirmed by non-limiting examples of implementation with the necessary supporting experimental data.

One of the components, namely polymeric methylene diphenyl diisocyanate, polymeric diphenylmethane diisocyanate, 4,4′-diphenylmethane diisocyanates, polymethylene polyphenylene polyisocyanates, polymeric MDI, polymethylene polyphenylene isocyanate ester, a mixture of mixed isomers of methylene diphenyl diisocyanate and carbodiimide-modified 4,4′-methylene diphenyl diisocyanate with a prepolymer based on polyoxypropylene glycol, or a mixture of any of these components, as well as another component, namely polyethers, polyesters, fire retardants, a catalyst, or a mixture of any of these components are mixed in a given qualitative and quantitative composition in a metal or plastic reactor using an anchor, paddle or any other mixer.

When mixing, the prepared mixture (prepolymer) is fed into an aerosol can.

The polymeric methylene diphenyl diisocyanate, polymeric diphenylmethane diisocyanate, 4,4′-diphenylmethane diisocyanates, polymethylene polyphenylene polyisocyanates, polymeric MDI, polymethylene polyphenylene isocyanate ester, a mixture of mixed isomers of methylene diphenyl diisocyanate and carbodiimide-modified 4,4′-methylene diphenyl diisocyanate with a prepolymer based on polyoxypropylene glycol, or a mixture of any of these components are fed through a separate dispenser.

After this, a valve is fitted onto the aerosol can. The next step is to dose the gas or gas mixture into the aerosol can through the fitted valve.

### Scope of Laboratory Tests Performed

Tests were carried out on three versions of the adhesive composition (two compositions from the prior art (product D, product M) and the claimed composition (product I), each of which is in its own container under pressure, i.e., in an aerosol can 1 (see FIG. 1).

The specified shear tests of aerosol formulations under compression loading were conducted in accordance with ASTM D905 (Reapproved 2021), “Standard Test Method for Strength Properties of Adhesive Bonds in Shear by Compression Loading”. Hard maple was used as a substrate in all product tests.

Conventionally, the first sample under study, namely adhesive composition No. 1, is referred to as “product D”, adhesive composition No. 2 is referred to as “product M”, and adhesive composition No. 3 (the claimed product) is referred to as “product I”.

Composition No. 3, namely “product I” (the proposed product) comprises:
(first component) polyethers, polyesters, flame retardants, catalysts, or mixtures of any of these components;
(second component) polymeric methylene diphenyl diisocyanate, polymeric diphenylmethane diisocyanate, 4,4′-diphenylmethane diisocyanates, polymethylenepolyphenylene polyisocyanates, polymeric MDI, polymethylenepolyphenylene isocyanate ester, a mixture of mixed isomers of methylene diphenyl diisocyanate and carbodiimide-modified 4,4′-methylene diphenyl diisocyanate with a polyoxypropylene glycol-based prepolymer, or a mixture of any of these components;
gas or gas mixture.

### Test Results for Composition No. 1 (Product D), No. 2 (Product M) and No. 3 (Proposed Product I)

### 1. Test Report

TABLE 1

| PROPERTY | PRODUCT | AVERAGE RESULTS |
|---|---|---|
| ASTM D905-08, | D (state of the art) | 59.3 psi |
| (Reapproved 2021), | M (state of the art) | 63.0 psi |
| Shear strength | I (claimed product) | 157 psi |

### 2. Test Method

The samples (prior art product D, prior art product M and proposed product I) were evaluated, as noted above, in accordance with the international standard ASTM D905-08, (Reapproved 2021) (Standard Test Method for Strength Properties of Adhesive Bonds in Shear by Compression Loading).

### 3. Origin of the Study Material

Three samples were examined and studied:
first sample (aerosol can with prior art product D);
second sample (aerosol can with a prior art product M);
third sample (aerosol can with the proposed product I).

Images of the study samples are shown in FIG. 1. The products were tested as presented, including sample preparation by spraying the starting material onto wooden substrates. Hard maple was used as a substrate in all product tests.

### 4. Test Structure

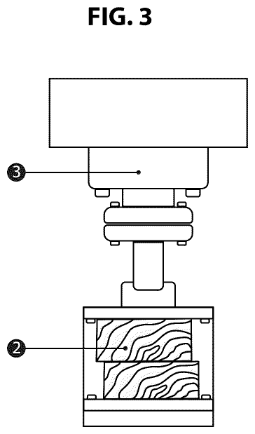

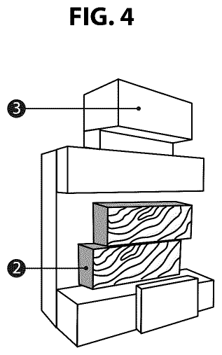

All conditions of the tests carried out and the condition of the samples under study correspond to standard laboratory conditions, FIG. 3 and FIG. 4 show standard setup 3 for performing shear tests under load.

The shear strength of the adhesive bonding of timber workpieces 2 was determined using a standard device, namely the 3 “SATEC UTM (ICN: Y002011)”, equipped with a 5000 lbf load cell (ICN: INT02615) and operating at a crosshead speed of 0.20 in/min. Compressive shear loads were applied to the surface of the wood blanks using a press structure until signs of failure appeared. The dimensions of the wooden blanks were measured using a digital caliper (ICN: INT01066).

### 5. Testing Results

### 5.1 Shear Strength of the Bond Under Compressive Load (Prior Art Product D)

TABLE 2

| Sample | | | Peak | Shear | |
|---|---|---|---|---|---|
| serial | Width | Length | Load | Strength | |
| number | (inches) | (inches) | (lbf) | (lb/in²) | Product type |
| 1 | 1.988 | 1.503 | 228 | 76.3 | Adhesive |
| | | | | | composition |
| 2 | 2.024 | 1.499 | 169 | 55.6 | Adhesive |
| | | | | | composition |
| 3 | 2.002 | 1.488 | 226 | 75.9 | Adhesive |
| | | | | | composition |
| 4 | 1.980 | 1.513 | 156 | 52.1 | Adhesive |
| | | | | | composition |
| 5 | 1.990 | 1.491 | 171 | 57.5 | Adhesive |
| | | | | | composition |
| 6 | 2.017 | 1.498 | 159 | 52.5 | Adhesive |
| | | | | | composition |
| 7 | 2.020 | 1.513 | 182 | 59.4 | Adhesive |
| | | | | | composition |
| 8 | 2.018 | 1.509 | 197 | 64.7 | Adhesive |
| | | | | | composition |
| 9 | 2.010 | 1.485 | 137 | 46.0 | Adhesive |
| | | | | | composition |
| 10 | 2.012 | 1.499 | 141 | 46.8 | Adhesive |
| | | | | | composition |
| 11 | 2.024 | 1.485 | 127 | 42.1 | Adhesive |
| | | | | | composition |
| 12 | 2.009 | 1.491 | 248 | 82.7 | Adhesive |
| | | | | | composition |
| 13 | 2.005 | 1.498 | 199 | 66.2 | Adhesive |
| | | | | | composition |
| 14 | 2.005 | 1.492 | 140 | 46.7 | Adhesive |
| | | | | | composition |
| 15 | 2.002 | 1.489 | 162 | 54.4 | Adhesive |
| | | | | | composition |
| 16 | 2.018 | 1.484 | 178 | 59.6 | Adhesive |
| | | | | | composition |
| 17 | 2.014 | 1.498 | 167 | 55.2 | Adhesive |
| | | | | | composition |
| 18 | 2.010 | 1.479 | 179 | 60.2 | Adhesive |
| | | | | | composition |
| 19 | 2.003 | 1.493 | 185 | 61.7 | Adhesive |
| | | | | | composition |
| 20 | 2.006 | 1.490 | 208 | 69.5 | Adhesive |
| | | | | | composition |
| Average | 2.008 | 1.495 | 178 | 59.3 | |
| Standard | 0.012 | 0.009 | 32.4 | 10.9 | |
| deviation | | | | | |

### 5.2. Shear Strength of the Bond Under Compressive Load (Prior Art Product M)

TABLE 3

| Sample | | | Peak | Shear | |
|---|---|---|---|---|---|
| serial | Width | Length | Load | Strength | |
| number | (inches) | (inches) | (lbf) | (lbs/in²) | Product type |
| 1 | 2.003 | 1.497 | 213 | 71.0 | Adhesive |
| | | | | | composition |
| 2 | 2.032 | 1.454 | 229 | 77.6 | Adhesive |
| | | | | | composition |
| 3 | 2.024 | 1.424 | 230 | 79.6 | Adhesive |
| | | | | | composition |
| 4 | 2.008 | 1.485 | 173 | 58.1 | Adhesive |
| | | | | | composition |
| 5 | 2.024 | 1.502 | 280 | 92.0 | Adhesive |
| | | | | | composition |
| 6 | 2.002 | 1.484 | 192 | 64.6 | Adhesive |
| | | | | | composition |
| 7 | 1.999 | 1.466 | 145 | 49.5 | Adhesive |
| | | | | | composition |
| 8 | 2.018 | 1.467 | 187 | 63.1 | Adhesive |
| | | | | | composition |
| 9 | 1.992 | 1.480 | 192 | 65.2 | Adhesive |
| | | | | | composition |
| 10 | 2.014 | 1.472 | 226 | 76.2 | Adhesive |
| | | | | | composition |
| 11 | 2.019 | 1.490 | 233 | 77.5 | Adhesive |
| | | | | | composition |
| 12 | 2.010 | 1.458 | 229 | 78.3 | Adhesive |
| | | | | | composition |
| 13 | 1.997 | 1.498 | 164 | 54.8 | Adhesive |
| | | | | | composition |
| 14 | 2.013 | 1.504 | 183 | 60.6 | Adhesive |
| | | | | | composition |
| 15 | 2.001 | 1.498 | 158 | 52.8 | Adhesive |
| | | | | | composition |
| 16 | 2.029 | 1.522 | 92.7 | 30.0 | Adhesive |
| | | | | | composition |
| 17 | 2.007 | 1.493 | 183 | 61.0 | Adhesive |
| | | | | | composition |
| 18 | 2.010 | 1.495 | 191 | 63.5 | Adhesive |
| | | | | | composition |
| 19 | 2.015 | 1.468 | 152 | 51.3 | Adhesive |
| | | | | | composition |
| 20 | 2.020 | 1.529 | 102 | 33.0 | Adhesive |
| | | | | | composition |
| Average | 2.012 | 1.484 | 188 | 63.0 | |
| Standard | 0.011 | 0.024 | 45.4 | 15.4 | |
| deviation | | | | | |

### 5.3 Shear Strength of the Bond Under Compressive Load (Proposed Product I)

TABLE 4

| Sample | | | Peak | Shear | |
|---|---|---|---|---|---|
| serial | Width | Length | Load | Strength | |
| number | (inches) | (inches) | (lbf) | (lbs/in²) | Product type |
| 1 | 2.006 | 1.512 | 193 | 63.5 | Adhesive |
| | | | | | composition |
| 2 | 2.009 | 1.491 | 590 | 197 | Adhesive |
| | | | | | composition |
| 3 | 2.007 | 1.500 | 117 | 38.9 | Adhesive |
| | | | | | composition |
| 4 | 2.004 | 1.499 | 449 | 150 | Adhesive |
| | | | | | composition |
| 5 | 2.015 | 1.483 | 575 | 193 | Adhesive |
| | | | | | composition |
| 6 | 2.004 | 1.498 | 549 | 183 | Adhesive |
| | | | | | composition |
| 7 | 2.003 | 1.496 | 536 | 179 | Adhesive |
| | | | | | composition |
| 8 | 2.013 | 1.493 | 120 | 40.1 | Adhesive |
| | | | | | composition |
| 9 | 2.009 | 1.486 | 167 | 55.8 | Adhesive |
| | | | | | composition |
| 10 | 2.011 | 1.491 | 752 | 251 | Adhesive |
| | | | | | composition |
| 11 | 2.022 | 1.494 | 543 | 180 | Adhesive |
| | | | | | composition |
| 12 | 1.981 | 1.485 | 1,530 | 520 | Adhesive |
| | | | | | composition |
| 13 | 2.012 | 1.485 | 320 | 107 | Adhesive |
| | | | | | composition |
| 14 | 2.011 | 1.500 | 715 | 237 | Adhesive |
| | | | | | composition |
| 15 | 2.006 | 1.490 | 777 | 260 | Adhesive |
| | | | | | composition |
| 16 | 2.015 | 1.510 | 467 | 154 | Adhesive |
| | | | | | composition |
| 17 | 2.014 | 1.502 | 218 | 72.1 | Adhesive |
| | | | | | composition |
| 18 | 2.001 | 1.500 | 222 | 73.8 | Adhesive |
| | | | | | composition |
| 19 | 2.003 | 1.497 | 160 | 53.3 | Adhesive |
| | | | | | composition |
| 20 | 2.011 | 1.492 | 410 | 137 | Adhesive |
| | | | | | composition |
| Average | 2.008 | 1.495 | 470 | 157 | |
| Standard | 0.008 | 0.008 | 329 | 112 | |
| deviation | | | | | |

In accordance with the obtained experimental data given in Tables [2]-[4] of the corresponding examples of the implementation of the invention, it was established that the tested samples (prior art product D, prior art product M and the proposed product I), according to international standards, have high reliability and efficiency of use, however, the proposed product I has improved reliability and efficiency indicators, and the wood material bonding strength indicators in the proposed product are noticeably higher than in the tested prior art products.

In addition, it was unexpectedly discovered during the experimental work that the gas component used in the claimed adhesive composition does not foam the adhesive composition inside container 1, due to which, when released, the adhesive composition does not have an aerosol structure, but has a paste (gel) consistency, which allows the product to be used with high precision and ergonomics, in particular, without wasting excessive amounts of glue.

The proposed invention can be successfully and effectively used in the construction industry as a multi-component gel-like or paste-like substance capable of bonding various structures, surfaces, parts, etc.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. A pressurized adhesive composition in an aerosol can, comprising:
a) the adhesive composition, when released from the aerosol can, has a consistency of a gel or paste; and
b) the adhesive composition has a shear strength of 80 psi or higher, when the adhesive composition is applied to wood.

2. The adhesive composition of claim 1, wherein the pressurized adhesive comprises:
a first component that includes any of (i) polyethers, polyesters, flame retardants and catalysts, or (ii) a mixture of polyethers, polyesters, flame retardants and catalysts;
a second component that includes any of polymeric methylene diphenyl diisocyanate, polymeric diphenylmethane diisocyanate, 4,4′-diphenylmethane diisocyanates, polymethylenepolyphenylene polyisocyanates, polymeric MDI, polymethylenepolyphenylene isocyanate ester, a mixture of mixed isomers of methylene diphenyl diisocyanate and carbodiimide(s)-modified, 4,4′-methylene diphenyl diisocyanate with a polyoxypropylene glycol-based prepolymer, or a mixture of any of these compounds; and
a gas or gas mixture.

3. The adhesive composition of claim 2, wherein at least some of the components are provided in the following proportions:

| | |
|---|---|
| | Percentage |
| | by weight |
| Component | range (%) |

First component

| | |
|---|---|
| Polyether(s) | 0-53 |
| Polyester(s) | 0-53 |
| Flame retardant(s) | 1.5-28 |
| Catalyst(s) | 0.1-2.5 |
| Mixture of any of the components | 0-83.5 |
| of the 1st component | |

Second component

| | |
|---|---|
| Polymeric methylene diphenyl | 0-95 |
| diisocyanate(s) | |
| Polymeric diphenylmethane | 0-95 |
| diisocyanate(s) | |
| 4,4′-diphenylmethane diisocyanate(s) | 0-95 |
| Polymethylenepolyphenylene | 0-95 |
| polyisocyanate(s) | |
| Polymeric MDI | 0-95 |
| Polymethylenepolyphenylene | 0-95 |
| isocyanate ester(s) | |
| A mixture of mixed isomer(s) of | 0-95 |
| methylene diphenyl diisocyanate and | |
| carbodiimide(s)-modified | |
| 4,4′-methylene diphenyl | 0-95 |
| diisocyanate(s) with a | |
| polyoxypropylene glycol-based | |
| prepolymer(s) | |
| Mixture of any of the components of | 0-95 |
| the 2nd component | |

Third component

| | |
|---|---|
| Gas or gas mixture | 2-38 |

4. The adhesive composition of claim 2, wherein at least some of the components are provided in the following proportions:

| | |
|---|---|
| | Percentage |
| | by weight |
| Component | range (%) |

First component

| | |
|---|---|
| Polyether(s) | 15-45 |
| Polyester(s) | 15-45 |
| Flame retardant(s) | 8.5-15 |
| Catalyst(s) | 0.4-1.2 |
| Mixture of any of the components of | 30-55 |
| the 1st component | |

Second component

| | |
|---|---|
| Polymeric methylene diphenyl | 35-58 |
| diisocyanate(s) | |
| Polymeric diphenylmethane | 35-58 |
| diisocyanate(s) | |
| 4,4′-diphenylmethane diisocyanate(s) | 35-58 |
| Polymethylenepolyphenylene | 35-58 |
| polyisocyanate(s) | |
| Polymeric MDI | 35-58 |
| Polymethylenepolyphenylene | 35-58 |
| isocyanate ester(s) | |
| A mixture of mixed isomer(s) of | 35-58 |
| methylene diphenyl diisocyanate and | |
| carbodiimide(s)-modified | |
| 4,4′-methylene diphenyl | 35-58 |
| diisocyanate(s) with a | |
| polyoxypropylene glycol-based | |
| prepolymer(s) | |
| Mixture of any of the components of | 35-58 |
| the 2nd component | |

Third component

| | |
|---|---|
| Gas or gas mixture | 9.2-22 |

5. The adhesive composition of claim 1, wherein the consistency of a gel or paste is provided by a polyurethane base.

6. The adhesive composition of claim 1, wherein the pressurized adhesive has a shear strength of 90 psi and higher, when the adhesive composition is applied to the wood.

7. The adhesive composition of claim 1, wherein the pressurized adhesive has a shear strength of 100 psi or higher, when the adhesive composition is applied to the wood.

8. The adhesive composition of claim 1, wherein the pressurized adhesive has a shear strength of 110 psi and higher, when the adhesive composition is applied to the wood.

9. The adhesive composition of claim 1, wherein the pressurized adhesive has a shear strength of 120 psi and higher, when the adhesive composition is applied to the wood.

10. The adhesive composition of claim 1, wherein the pressurized adhesive has a shear strength of 130 psi and higher, when the adhesive composition is applied to the wood.

11. The adhesive composition of claim 1, wherein the pressurized adhesive has a shear strength of 140 psi and higher, when the adhesive composition is applied to the wood.

12. The adhesive composition of claim 1, wherein the pressurized adhesive has a shear strength of 150 psi and higher, when the adhesive composition is applied to the wood.
